(19) United States
(12) Patent Application Publication
(10) Pub. No.: US 2025/0284823 A1
(43) Pub. Date: Sep. 11, 2025

(54) METHOD AND SYSTEM FOR GENERATING VULNERABILITY REPORT FOR A PRODUCT

(71) Applicant: HCL Technologies Limited, New Delhi (IN)

(72) Inventors: Veera Venkata Paparao Gokavarapu, Bangalore (IN); Mahipat Rao Kulkarni, Bangalore (IN); Mythilinath N V S, Bangalore (IN)

(21) Appl. No.: 19/071,808

(22) Filed: Mar. 6, 2025

(30) Foreign Application Priority Data
Mar. 8, 2024 (IN) 202411016666

(51) Int. Cl. G06F 21/57

(52) U.S. Cl. CPC G06F 21/577; G06F 2221/033

(57) ABSTRACT

A method for generating a vulnerability report for a product is disclosed. The method includes obtaining a set of parameters corresponding to the product associated with a user device. The set of parameters includes a product name, a pre-installed product version, a license information, and user device configurations. The method further includes analysing a database to determine one of a presence or an absence of vulnerability information associated with the product within the database. The method further includes extracting the vulnerability information for the product, upon determining the presence of the vulnerability information. The method further includes validating each of the set of parameters based on the vulnerability information extracted for the product. The method includes generating a vulnerability report corresponding to the product in a pre-defined format based on the validating.

### TECHNICAL FIELD

This disclosure relates generally to cybersecurity and vulnerability management, and more particularly to a method and a system for generating a vulnerability report for a product.

### BACKGROUND

Understanding software product vulnerabilities is a fundamental requirement for managing modern security threats in software products. Organizations encounter these vulnerabilities in their software products on a regular basis that need to be remediated at scheduled releases. A software product vulnerability is a defect in a software product that could allow a hacker to gain control of a customer's device. In other words, the software product vulnerability may refer to a flaw in the software product that can be exploited by hackers to compromise an integrity, confidentiality, or availability of the software product or customer data it handles. These vulnerabilities can exist in various forms, including coding errors, design flaws, configuration mistakes, or insecure implementation of features. Exploiting these vulnerabilities can lead to a range of security threats or risks, including unauthorized access to sensitive information stored on the customer device, disruption of services, and unauthorized modification of the customer data.

Currently, only a fraction of customers employ sophisticated vulnerability detection tools to identify the vulnerabilities within the software product and report these vulnerabilities to a support team of an organization to get a remediated version of the software product. However, most of the existing vulnerability detection tools used for detecting vulnerabilities are licensed versions, which require investment and a skilled workforce. Hence, not all the customers are able to afford it. Further, major challenges arise when certain customers are not willing to upgrade their software product for any reason. In such cases, these customers may lack comprehensive information regarding vulnerable components of the software products, leaving their devices susceptible to exploitation by malicious actors. This scenario poses significant risks to the customers and their data, potentially resulting in severe implications and financial losses.

Thus, the techniques in the present state of art fail to address the problem of generating a vulnerability report for a product.

### SUMMARY

In one embodiment, a method for generating a vulnerability report for a product is disclosed. In one example, the method may include obtaining a set of parameters corresponding to the product associated with a user device. The set of parameters may include a product name, a pre-installed product version, a license information, and user device configurations. The method may include analysing a database to determine one of a presence or an absence of vulnerability information associated with the product within the database. It should be noted that the vulnerability information may include one or more issues associated with a current product version and each of a set of existing product versions of the product. The method may include extracting the vulnerability information for the product, upon determining the presence of the vulnerability information in response to analysing. The method may include validating each of the set of parameters based on the vulnerability information extracted for the product. The method may include generating a vulnerability report corresponding to the product in a pre-defined format based on the validating. It should be noted that the vulnerability report may include information associated with the current product version and each of the set of existing product versions.

In one embodiment, a system for generating a vulnerability report for a product is disclosed. The system may include a processor and a memory communicatively coupled to the processor. The memory may store processor-executable instructions, which, on execution, may cause the processor to obtain a set of parameters corresponding to the product associated with a user device. The set of parameters may include a product name, a pre-installed product version, a license information, and user device configurations. The processor-executable instructions, on execution, may further cause the processor to analyse a database to determine one of a presence or an absence of vulnerability information associated with the product within the database. It should be noted that the vulnerability information comprises one or more issues associated with a current product version and each of a set of existing product versions of the product. The processor-executable instructions, on execution, may further cause the processor to extract the vulnerability information for the product, upon determining the presence of the vulnerability information in response to analyse. The processor-executable instructions, on execution, may further cause the processor to validate each of the set of parameters based on the vulnerability information extracted for the product. The processor-executable instructions, on execution, may further cause the processor to generate a vulnerability report corresponding to the product in a pre-defined format based on the validating. It should be noted that the vulnerability report may include information associated with the current product version and each of the set of existing product versions.

In one embodiment, a non-transitory computer-readable medium storing computer-executable instructions for generating a vulnerability report for a product is disclosed. The stored instructions, when executed by a processor, may cause the processor to perform operations including obtaining a set of parameters corresponding to the product associated with a user device. The set of parameters may include a product name, a pre-installed product version, a license information, and user device configurations. The operations may further include analysing a database to determine one of a presence or an absence of vulnerability information associated with the product within the database. It should be noted that the vulnerability information may include one or more issues associated with a current product version and each of a set of existing product versions of the product. The operations may include extracting the vulnerability information for the product, upon determining the presence of the vulnerability information in response to analysing. Further, the operations may include validating each of the set of parameters based on the vulnerability information extracted for the product. The operations may further include generating a vulnerability report corresponding to the product in a pre-defined format based on the validating. It should be noted that the vulnerability report may include information associated with the current product version and each of the set of existing product versions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary system configured for generating a vulnerability report for a product, in accordance with some embodiments of the present disclosure.

FIG. 2 illustrates a functional block diagram of various modules within a memory of a server configured to generate a vulnerability report for a product, in accordance with some embodiments of the present disclosure.

FIG. 3 illustrates a flow diagram of an exemplary process for generating a vulnerability report for a product, in accordance with some embodiments of the present disclosure.

FIG. 4 illustrates a flow diagram of an exemplary process for updating vulnerability information associated with a product, in accordance with some embodiments of the present disclosure.

FIG. 5 illustrates a flow diagram of a detailed exemplary process performed at a client side for rendering a vulnerability report, in accordance with some embodiments of the present disclosure.

FIG. 6 illustrates a flow diagram of a detailed exemplary process performed at a server side for generating a vulnerability report, in accordance with some embodiments of the present disclosure.

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

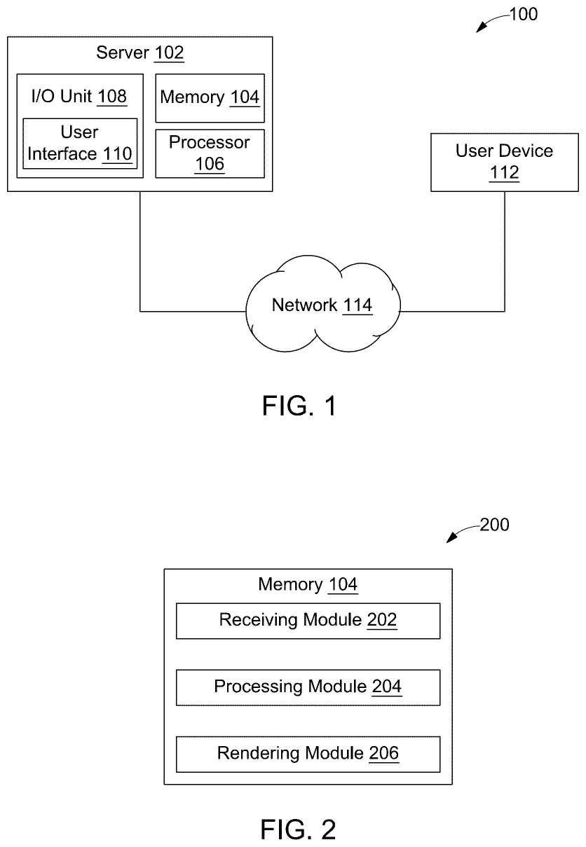

Referring now to FIG. 1, a block diagram of an exemplary system 100 configured for generating a vulnerability report for a product is illustrated, in accordance with some embodiments of the present disclosure. In order to generate the vulnerability report for the product, the system 100 may include a server 102. The server 102 may be configured to generate the vulnerability report for the product. Examples of the server 102 may include, but are not limited to, an application server, a desktop, a laptop, a notebook, a netbook, a tablet, a smartphone, and the like. In an embodiment, the product may correspond to one of a software product, a software application, or a firmware.

In order to generate the vulnerability report, initially the server 102 may obtain a set of parameters corresponding to the product associated with a user device 112. Examples of the user device 112 may include, but are not limited to, a desktop, a laptop, a notebook, a netbook, a tablet, a smartphone, and the like. By way of an example, the product associated with the user device 112 may correspond to a software application pre-installed on the user device 112. Further, the set of parameters associated with the user device 112 may include a product name, a pre-installed product version, a license information, and user device configurations. As will be appreciated, the set of parameters is obtained from a user of the user device 112. Once the set of parameters is obtained, the server 102 may be configured to analyse a database (not shown). In an embodiment, the database may be present within a memory 104 of the server 102. In some embodiments, the database may correspond to a database of an another cloud server.

The server 102 may analyze the database to determine one of a presence or an absence of vulnerability information associated with the product within the database. The database may include vulnerability information associated with a plurality of products. It should be noted that the database may be updated with the vulnerability information before release of each product version of each of the plurality of products. In an embodiment, the vulnerability information may include one or more issues associated with a current product version and each of a set of existing product versions of the product. The one or more issues may include issues associated with components, ports, platforms, web services, an End of Life (EOL) of associated third party components, and an EOL of the product.

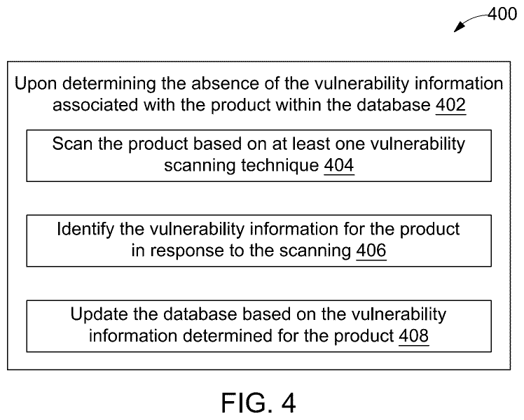

Further, based on the analysis of the database, the server 102 may be configured to extract the vulnerability information for the product. In an embodiment, the server 102 may extract the vulnerability information upon determining the presence of the vulnerability information within the database. In other words, based on the analysis, when the presence of the vulnerability information associated with the product is determined within the database based on the analysis, the server 102 may extract the vulnerability information for the product from the database. In some embodiments, upon determining the absence of the vulnerability information within the database, the server 102 may update the database with the vulnerability information associated with the product. A method of updating the database with the vulnerability information is further explained in detail in conjunction with FIG. 4.

Upon extracting the vulnerability information, the server 102 may validate each of the set of parameters based on the vulnerability information extracted for the product. Further, based on the validation, the server 102 may generate a vulnerability report corresponding to the product. The vulnerability information may be generated in a pre-defined format. It should be noted that the vulnerability report may include information associated with the current product version and each of the set of existing product versions. Further, the information may include a common vulnerability exposure (CVE) list, an impact, a remediated product version, false positives, and a download link.

Once the vulnerability report is generated, the server 102 may transmit the vulnerability report to the user device 112. In an embodiment, the server 102 may transmit the vulnerability report to the user device 112 over a network 114. The network 114, for example, may be any wired or wireless communication network, and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). Further, the vulnerability report transmitted to the user device 112 may be rendered to the user via a Graphical User Interface (GUI) of the user device 112.

In some embodiments, the server 102 may include the memory 104 and one or more processors 106. Further, the memory 104 may store instructions that, when executed by the processor 106, cause the processor 106 to generate the vulnerability report for the product. As will be described in greater detail in conjunction with FIG. 2 to FIG. 6, in order to generate the vulnerability report, the processor 106 in conjunction with the memory 104 may perform various functions including obtaining the set of parameters corresponding to the product associated with the user device 112, analysing the database to determine one of the presence or the absence of vulnerability information, extracting the vulnerability information, validating each of the set of parameters based on the vulnerability information, and generating a vulnerability report corresponding to the product.

The memory 104 may also store various data (for example, the set of parameters, the vulnerability information, the vulnerability report, and the like) that may be captured, processed, and/or required by the server 102. The memory 104 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.). In some embodiments, the server 102 may further include an Input/Output unit 108. The I/O unit 108 may further include a user interface 110. In some embodiments, the user may interact with the server 102 and vice versa through the I/O unit 108. The I/O unit 108 may be used to display results (i.e., the set of parameters, the vulnerability report, etc.) based on actions performed by the server 102 to the user. The user interface 110 may be used by the user to provide inputs to the server 102.

Referring now to FIG. 2, a functional block diagram 200 of various modules within a memory 104 of a server 102 configured to generate a vulnerability report for a product is illustrated, in accordance with some embodiments of the present disclosure. FIG. 2 is explained in conjunction with FIG. 1. To generate the vulnerability report for the product, the memory 104 may include a receiving module 202, a processing module 204, and a rendering module 206.

Initially, the receiving module 202 may obtain a set of parameters corresponding to the product associated with a user device. With reference to FIG. 1, the user device may correspond to the user device 112. Examples of the user device 112 may include, but are not limited to, a desktop, a laptop, a notebook, a netbook, a tablet, a smartphone, and the like. In an embodiment, the product may correspond to one of a software product, a software application, or a firmware. The set of parameters may include a product name, a pre-installed product version, a license information, and user device configurations. It should be noted that the receiving module 202 may obtain the set of parameters corresponding to the user device 112 from a user of the user device 112. By way of an example, the user may fill the set of parameters corresponding to product in a form rendered to the user via the GUI of the user device 112. Upon obtaining the set of parameters, the receiving module 202 may be configured to send the set of parameters to the processing module 204.

Further, upon receiving the set of parameters, the processing module 204 may be configured to analyse a database (not shown) to determine one of a presence or an absence of vulnerability information associated with the product. As will be appreciated the database may be present within the memory 104. In an embodiment, the database may include vulnerability information associated with a plurality of products. It should be noted that the database may be updated with the vulnerability information before release of each product version of each of the plurality of products by the processing module 204. The processing module 204 may identify the vulnerability information based on at least one vulnerability scanning technique. The at least one vulnerability scanning technique may include, but is not limited to, a Black Duck scanning technique, a Nessus scanning technique, a Nexpose scanning technique, a Webapp scanning technique, and a penetration testing technique.

The vulnerability information may include one or more issues associated with a current product version and each of a set of existing product versions of the product. Further, the one or more issues may include issues associated with components, ports, platforms, web services, an EOL of associated third party components, and an EOL of the product. In an embodiment, the processing module 204 may correspond to Intelligent Security Vulnerability Engine (ISVE). Further, based on the analysis, in one embodiment, upon determining the presence of the vulnerability information within the database, the processing module 204 may be configured to extract the vulnerability information for the product. Once the vulnerability information is extracted, the processing module 204 may validate each of the set of parameters based on the vulnerability information extracted for the product.

In another embodiment, upon determining the absence of the vulnerability information, the processing module 204 may be configured to scan the product based on the at least one vulnerability scanning technique. Further, the processing module 204 may identify the vulnerability information for the product in response to the scanning. In other words, based on the scanning of the product using the at least one vulnerability scanning technique, the processing module 204 may identify the vulnerability information associated with the product. Upon identifying the vulnerability information, the processing module 204 may be configured to update the database based on the vulnerability information determined for the product. In this embodiment, in addition to updating the database, the processing module 204 may use the identified vulnerability information to validate each of the set of parameters of the product associated with the user device 112.

Once each of the set of parameters is validated, the processing module 204 may be configured to generate a vulnerability report corresponding to the product based on the validation. In an embodiment, the vulnerability report may be generated in a pre-defined format. Examples of the pre-defined format may include, but are not limited to, Extensible Markup Language (XML) format, JavaScript Object Notation (JSON) format, Hypertext Markup Language (HTML) format, Comma-separated Values (CSV) format, Portable Document Format (PDF), and the like. The vulnerability report may include information associated with the current product version and each of the set of existing product versions. The information, for example, may include a common vulnerability exposure (CVE) list, an impact, a remediated product version, false positives, a download link, and the like. Once the vulnerability report is generated, the processing module 204 may be configured to send the vulnerability report to the rendering module 206.

Further, upon receiving the vulnerability report, the rendering module 206 may be configured to transmit the vulnerability report to the user device 112. With reference to FIG. 1, the rendering module 206 may transmit the vulnerability report to the user device 112 over the network 114. By way of an example, the rendering module 206 may transmit the vulnerability report to the user device 112 via an email of a user of the user device 112. Further, the rendering module 206 may be configured to render the vulnerability report to the user via the Graphical User Interface (GUI) of the user device 112.

It should be noted that all such aforementioned modules 202-206 may be represented as a single module or a combination of different modules. Further, as will be appreciated by those skilled in the art, each of the modules 202-206 may reside, in whole or in parts, on one device or multiple devices in communication with each other. In some embodiments, each of the modules 202-206 may be implemented as dedicated hardware circuit comprising custom application-specific integrated circuit (ASIC) or gate arrays, off-the-shelf semiconductors such as logic chips, transistors, or other discrete components. Each of the modules 202-206 may also be implemented in a programmable hardware device such as a field programmable gate array (FPGA), programmable array logic, programmable logic device, and so forth. Alternatively, each of the modules 202-206 may be implemented in software for execution by various types of processors (e.g., processor 106). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating a vulnerability report for a product. For example, the exemplary system 100 and the server 102 may generate a vulnerability report for a product by the processes discussed herein. In particular, as will be appreciated by those of ordinary skill in the art, control logic and/or automated routines for performing the techniques and steps described herein may be implemented by the system 100 and the associated server 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

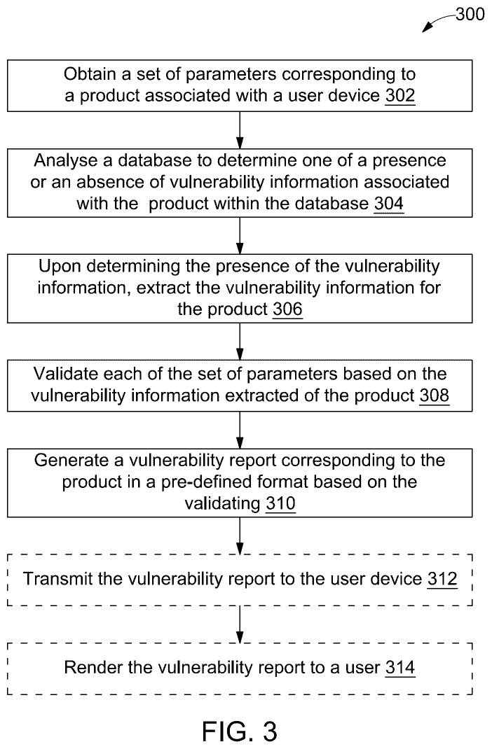

Referring now to FIG. 3, an exemplary process 300 for generating a vulnerability report for a product is depicted via a flowchart, in accordance with some embodiments of the present disclosure. FIG. 3 is explained in conjunction with FIGS. 1 and 2. Each step of the process 300 may be implemented by the server 102 of the system 100.

In order to generate the vulnerability report, initially, at step 302, a set of parameters corresponding to the product associated with a user device may be obtained. With reference to FIG. 1, the user device may correspond to the user device 112. Examples of the user device may include, but are not limited to, a desktop, a laptop, a notebook, a netbook, a tablet, a smartphone, and the like. Further, the product may correspond to one of a software product, a software application, or a firmware. In an embodiment, the set of parameters may include a product name, a pre-installed product version, a license information, and user device configurations. By way of an example, the product associated with the user device, for example, may be a software product (e.g., Adobe Creative Cloud) installed within the user device (e.g., a laptop). In this example, the set of parameters may be a version of the Adobe Creative Cloud that is installed in the laptop of a user (i.e., the pre-installed product version), a license information associated with the Adobe Creative Cloud, and configuration of the laptop used by the user (i.e., the user device configurations). Further, the set of parameters corresponding to the Adobe Creative Cloud may be obtained from the user of the laptop.

Further, at step 304, a database may be analysed to determine one of a presence or an absence of vulnerability information associated with the product within the database. The vulnerability information may include one or more issues associated with a current product version and each of a set of existing product versions of the product. Further, the one or more issues may include issues associated with components, ports, platforms, web services, an EOL of associated third party components, and an EOL of the product. In an embodiment, the one or more issues may be either from proprietary code or any third-party component. It should be noted that the database may include vulnerability information associated with a plurality of products. Further, the database may be updated with the vulnerability information before release of each product version of each of the plurality of products. In an embodiment the vulnerability information associated with the product may be identified based on at least one vulnerability scanning technique. The at least one vulnerability scanning technique may include, but is not limited to, a Black Duck scanning technique, a Nessus scanning technique, a Nexpose scanning technique, a Webapp scanning technique, and a penetration testing technique.

In continuation to the above example, where the product is the Adobe Creative Cloud and the user device is the laptop in this example, the vulnerability information associated with the Adobe Creative Cloud may include one or more issues associated with a current version (i.e., the current product version) and each of a set of existing versions (i.e., the set of existing product versions) associated with the Adobe Creative Cloud. The one or more issues, in this example, may include issues associated with components, ports, platforms, web services, an EOL of associated third party components, and an EOL of the Adobe Creative Cloud.

Further, based on the analysis, upon determining the presence of the vulnerability information within the database, at step 306, the vulnerability information for the product may be extracted from the database. Upon extracting the vulnerability information from the database, at step 308, each of the set of parameters may be validated based on the vulnerability information extracted for the product. In continuation to the above example, once the vulnerability information associated with the Adobe Creative Cloud is extracted, then the set of parameters may be validated based on the vulnerability information. For example, the version of the Adobe Creative Cloud that is installed in the laptop of the user may be validated based on the issues associated with the components, the ports, the platforms, the web services, the EOL of associated third party components, and the EOL of the Adobe Creative Cloud with respect to the pre-installed version. This is done to validate whether the user should use the pre-installed version or not or identify any upgrade that might have happened in the pre-installed version. By way of another example, if the user may be interested in downloading a new version (i.e., the current version) of the Adobe Creative Cloud. In this case, the set of parameters may be validated based on the vulnerability information. This is done to validate whether the user can download the new version or should use the pre-installed version.

Further, based on the validation of the set of parameters, at step 310, a vulnerability report corresponding to the product may be generated. The vulnerability report may be generated in a pre-defined format. Examples of the pre-defined format may include, but are not limited to, an XML format, a JSON format, a HTML format, a CSV format, a PDF, and the like. In an embodiment, the vulnerability report may include information associated with the current product version and each of the set of existing product versions. The information may include a CVE list, an impact, a remediated product version, false positives, and a download link. In continuation to the above example, once the set of parameters are validated based on the vulnerability information associated with the Adobe Creative Cloud, the vulnerability report may be generated, for example, in the XML format. The generated vulnerability report may provide the information including the CVE list, an impact, a remediated product version, false positives, and a download link (e.g., the download link of the new version) associated with the new version and each of the set of existing versions of the Adobe Creative Cloud associated with the laptop.

Once the vulnerability report is generated, the generated vulnerability report may be transmitted to the user device 112 as mentioned via step 312. As will be appreciated, in some embodiments, the vulnerability report may be transmitted to the user device 112 via an email of the user. Further, the generated vulnerability report may be rendered to the user via a GUI of the user device 112. The vulnerability report helps the user to be aware of any security laps within the current product version or each of the set of existing product versions of the product. In continuation to the above example, in an embodiment, the generated vulnerability report may enable the user to be aware of any security issues (includes threats or risk) that are recently encountered in the version of the Adobe Creative Cloud that is installed in the laptop of the user. Further, in another embodiment, the generated vulnerability report may provide details of any security issues that are discovered in the new version of Adobe Creative Cloud and compatibility issues of the new version with the laptop based on configuration of the laptop. The user may use the information provided in the vulnerability report to take appropriate action, for example, whether the user should install the product or not, stick to the pre-installed product version, download the new version or not, and the like.

Referring now to FIG. 4, a flow diagram of an exemplary process 400 for updating vulnerability information associated with a product is illustrated via a flowchart, in accordance with some embodiments of the present disclosure. FIG. 4 is explained in conjunction with FIGS. 1, 2, and 3. Each step of the process 400 may be performed by the server 102 of the system 100.

With reference to FIG. 3, based on the analysis performed at the step 304, upon determining the absence of the vulnerability information associated with the product within the database as mentioned via step 402, at step 404, the product may be scanned. The scanning of the product may be done based on at least one vulnerability scanning technique. Examples of the at least one vulnerability scanning technique may include, but is not limited to, a Black Duck scanning technique, a Nessus scanning technique, a Nexpose scanning technique, a Webapp scanning technique, and a penetration testing technique. In other words, apart from the examples of the at least one vulnerability scanning technique any other existing scanning technique may be used.

Further, based on the scanning, at step 406, the vulnerability information for the product may be identified. In particular, in some embodiments, the vulnerability information associated with the product may be identified by scanning a source code or a binary code of the product (e.g., a software application) to detect instances of known vulnerabilities or licensing conflicts. Upon identifying the vulnerability information, at step 408, the database may be updated based on the vulnerability information determined for the product. With reference to FIG. 3, once the vulnerability information associated with the product is updated within the database, then the step 308 to the step 314 may be executed.

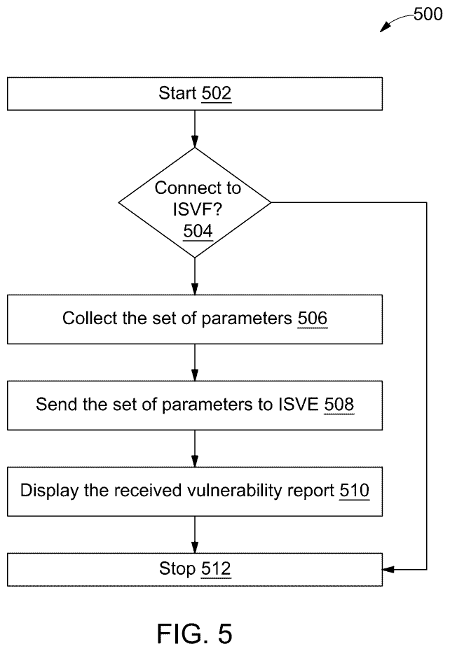

Referring now to FIG. 5, a flow diagram of a detailed exemplary process 500 performed at a client side for rendering a vulnerability report is illustrated via a flowchart, in accordance with some embodiments of the present disclosure. FIG. 5 is explained in conjunction with FIGS. 1, 2, 3, 4, and 5. Each of the process 500 may be performed on the user device 112. In an embodiment, the process 500 performed at the client side may correspond to a process performed on the user device 112.

In order to render the vulnerability report, initially during start of the process at step 502, an option, e.g., ‘do you want to connect to the ISVE’ may be displayed to the user as mentioned via step 504. In other words, a check may be performed to determine if the user of the user device 112 is interested in connecting with the ISVE by displaying the option. By way of an example, the option may be displayed to the user when the user may install a new product, or a new version of a pre-installed product. In some embodiments, the option may be periodically displayed to the user when the user has enabled a functionality (e.g., establish connection with the ISVE) associated with the product (either the new product or the pre-installed product). In other words, the functionality, ‘establish connection with ISVE’ may be integrated within the product. With reference to FIG. 2, the ISVE may correspond to the processing module 204 within the memory 104 of the server 102. In an embodiment, the product may correspond to one of a software product, a software application, or a firmware.

In one embodiment, based on the option, i.e., ‘do you want to connect to the ISVE’ rendered to the user, if the user selects a ‘Yes icon’, then at step 506, the set of parameters corresponding to the product associated with the user device 112 may be collected. In some embodiments, once the user selects the ‘Yes icon’ to establish connection with ISVE, then new vulnerability information corresponding to each product version of each of the plurality of products may be periodically updated within the database. In order to collect the set of parameters, upon selecting the ‘Yes icon’, a form may be rendered to the user via the GUI of the user device 112. The user may fill in the form with requested details (i.e., the set of parameters). In other words, upon selecting the ‘Yes icon’, the user device 112 may receive the form from the server 102. The set of parameters comprises the product name, the pre-installed product version, the license information, and the user device configurations.

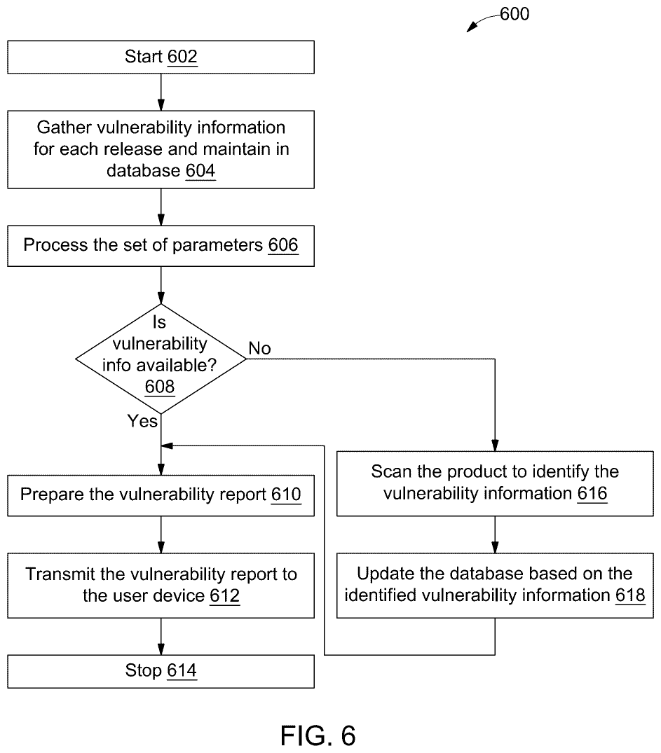

Upon collecting the set of parameters corresponding to the product associated with the user device 112, at step 508, the collected set of parameters of the product may be sent to the ISVE. In other words, with reference to FIG. 1, the collected set of parameters may be sent by the user device 112 to the server 102. Further, the server 102 may process the set of parameters to generate the vulnerability report for the product. This has been further explained in detail in conjunction with FIG. 6. Once the vulnerability report is generated, the server 102 may transmit the generated vulnerability report to the user device 112. As already explained in FIG. 2, the receiving module 202 within the memory 104 of the server 102 may receive the set of parameters. Further, the receiving module 202 may send the set of parameters to the processing module 204 (i.e., the ISVE) for further processing.

In response to sending the set of parameters, the user device 112 may receive the vulnerability report corresponding to the product. The received vulnerability report may be displayed (i.e., rendered) to the user as mentioned via step 510. The vulnerability report may be displayed via the GUI of the user device 112 in the pre-defined format. Once the vulnerability report is displayed the process 500 may end at step 512. Further, the user may utilize the vulnerability report to perform an appropriate action based on his requirement. For example, the action may include whether the user should install the product or not, stick to the pre-installed product version, download the new version or not, and the like. In another embodiment, based on the option, i.e., ‘do you want to connect to the ISVE’ rendered to the user, if the user selects a ‘No icon’, then the set of parameters may not be collected and transmitted to the ISVE. Further, based on a user selection of the ‘No icon’, the step 512 may be directly executed.

Referring now to FIG. 6, a flow diagram of a detailed exemplary process 600 performed at a server side for generating a vulnerability report is illustrated via a flowchart, in accordance with some embodiments of the present disclosure. FIG. 6 is explained in conjunction with FIGS. 1, 2, 3, 4, and 5. Each step of the process 600 may be performed by the server 102 of the system 100. In other words, the process 600 performed at the server side may correspond to a process performed at the server 102.

In order to generate the vulnerability report, during start of the process 600 at step 602, initially, at step 604, the vulnerability information corresponding to each product version may be gathered before release of each product version of each of the plurality of products. Further, the gathered vulnerability information may be stored in the database (i.e., the database of the server 102). In some embodiments, the vulnerability information corresponding to each product version of each of the plurality of products may be periodically gathered and updated within the database. In other words, any security issues encountered within each product version during its usage may be gathered and stored in the database. With reference to FIG. 2, the processing module 204, i.e., the ISVE, may be configured to collect the vulnerability information associated with each product version of each of the plurality of products. In an embodiment, the vulnerability information may include the one or more issues associated with the current product version and each of the set of existing product versions of the product. Further, the one or more issues may include issues associated with the components, the ports, the platforms, the web services, the EOL of associated third party components, and the EOL of the product.

Further, after obtaining the set of parameters from the user device 112, at step 606, the set of parameters received corresponding to the product associated with the user device 112 may be processed. The processing may be done via the ISVE. To process the set of parameters, at step 608, a check may be performed to determine whether the vulnerability information corresponding to the current product version and each of the set of existing product versions of the product is present within the database. The check may be performed by the ISVE. In other words, the database may be analysed to detect one of the presence or the absence of the vulnerability information within the database.

In response to performing the check, in one embodiment, upon determining the presence of the vulnerability information within the database, step 610 may be executed. At step 610, upon determining the presence of the vulnerability information, the ISVE may extract the vulnerability information corresponding to the product from the database. Once the vulnerability information is extracted, at step 610, each of the set of parameters corresponding to the product associated with the user device 112 may be validated based on the extracted vulnerability information to prepare the vulnerability report. Further, based on the validation, the vulnerability report corresponding to the product may be generated.

The generated vulnerability report may provide the information including the CVE list, the impact, the remediated product version, the false positives, and the download link (e.g., the download link of the current product version) corresponding to the product associated with the user device 112. It should be noted that the vulnerability report may be generated in the pre-defined format. Examples of the pre-defined format may include, but are not limited to, an XML format, a JSON format, an HTML format, a CSV format, a PDF, and the like. Once the vulnerability report is generated, at step 612, the ISVE may be configured to transmit the vulnerability report to the user device 112 corresponding to the product. The vulnerability report may be transmitted in the pre-defined format. As will be appreciated, in some embodiments, the vulnerability report may be transmitted to the user device 112 via an email of the user. Once the vulnerability report is transmitted, the process 600 may end at step 614.

Further, with reference to FIG. 5, the transmitted vulnerability report may be rendered to the user via the GUI of the user device 112, as mentioned via the step 510. It should be noted that the vulnerability report may help the user to be aware of any security laps within the current product version or each of the set of existing product versions of the product. The user may use the information provided in the vulnerability report to take an appropriate action, for example, whether the user should install the product or not, stick to the pre-installed product version, download the new version or not, and the like.

In response to performing the check, in another embodiment, upon determining the absence of the vulnerability information within the database at step 608, step 616 may be executed. At step 616, the product may be scanned to identify the vulnerability information corresponding to the product. In other words, the current product version and each of the set of existing product versions may be scanned by the ISVE to identify the vulnerability information for the product based on the at least one vulnerability scanning technique. It should be noted that at least one vulnerability scanning technique may include but is not limited to the Black Duck scanning technique, the Nessus scanning technique, the Nexpose scanning technique, the Webapp scanning technique, and the penetration testing technique. Upon identifying the vulnerability information corresponding to the product, at step 618, the ISVE may be configured to update the database based on the vulnerability information identified for the product. Further, in addition to updating the database, the steps 610 and 612 may be executed by the ISVE to generate the vulnerability report for the product based on the identified vulnerability information. Once the vulnerability report is generated and transmitted, the process 600 may end at the step 614.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

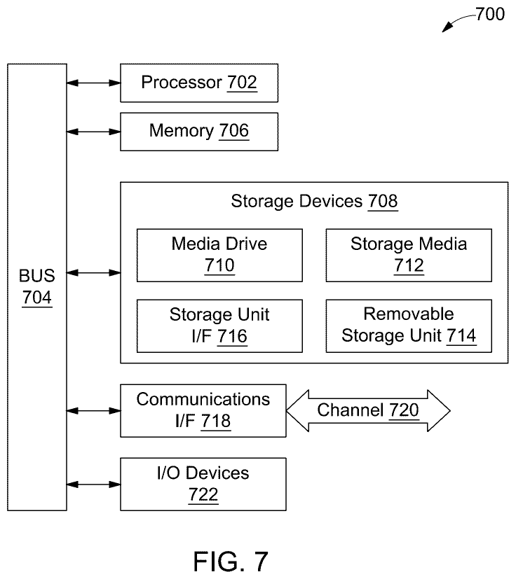

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication medium. In some embodiments, the processor 702 may be an Artificial Intelligence (Al) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 702.

The computing system 700 may also include a storage device 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

Various embodiments provide a method and a system for generating a vulnerability report for a product. The disclosed method and system may obtain a set of parameters corresponding to the product associated with a user device. The set of parameters may include a product name, a pre-installed product version, a license information, and user device configurations. Further, the disclosed method and system may analyse a database to determine one of a presence or an absence of vulnerability information associated with the product within the database. The vulnerability information may include one or more issues associated with a current product version and each of a set of existing product versions of the product. Further, in response to analysing, the disclosed method and system may extract the vulnerability information for the product, upon determining the presence of the vulnerability information. Additionally, the disclosed method and system may validate each of the set of parameters based on the vulnerability information extracted for the product. Thereafter, the disclosed method and system may generate a vulnerability report corresponding to the product in a pre-defined format based on the validating. The vulnerability report may include information associated with the current product version and each of the set of existing product versions.

Thus, the disclosed method and system try to overcome the technical problem of generating a vulnerability report for a product. The disclosed method and system may provide on demand vulnerability details (i.e., information including the CVE list, the impact, the remediated product version, false positives, and the download link associated with the current product version and each of the set of existing product versions of the product) to customers via the vulnerability report. This may help the customers to be aware of vulnerabilities within the product. In other words, the vulnerability details described in the vulnerability report may help the customers to be aware of any security laps (i.e., security threats or risks) associated with the product. Further, the disclosed method and system may automate a process of discovering vulnerabilities within products (e.g., software products, software applications, or firmware's), saving time and effort of both the customers and the organizations. This ensures that the vulnerabilities are identified promptly, reducing a window of opportunity for potential attacks. In addition, the disclosed method and system may identify not only identify known vulnerabilities but also potential unknown or emerging threats (including both functional as well as security threats). Further, unlike existing licensed vulnerability scanning tools that require significant investment, the disclosed method and system may provide accessibility to a wider range of the customers, regardless of their financial resources, ensuring that all the customers can take proactive measures to secure their devices (e.g., the user device 112). Moreover, the disclosed method and the system may support continuous monitoring of the products and user devices for new vulnerabilities, ensuring ongoing protection against evolving threats.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and a system for generating a vulnerability report for a product. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating a vulnerability report for a product, the method comprising:
obtaining, by a server, a set of parameters corresponding to the product associated with a user device, wherein the set of parameters comprises a product name, a pre-installed product version, a license information, and user device configurations;
analysing, by the server, a database to determine one of a presence or an absence of vulnerability information associated with the product within the database, wherein the vulnerability information comprises one or more issues associated with a current product version and each of a set of existing product versions of the product;
in response to analysing, extracting, by the server, the vulnerability information for the product, upon determining the presence of the vulnerability information;
validating, by the server, each of the set of parameters based on the vulnerability information extracted for the product; and
generating, by the server, a vulnerability report corresponding to the product in a pre-defined format based on the validating, wherein the vulnerability report comprises information associated with the current product version and each of the set of existing product versions.

2. The method of claim 1, wherein the database comprises vulnerability information associated with a plurality of products, and wherein the database is updated with the vulnerability information before release of each product version of each of the plurality of products.

3. The method of claim 1, wherein the one or more issues comprises issues associated with components, ports, platforms, web services, an End of Life (EOL) of associated third party components, and an EOL of the product.

4. The method of claim 1, further comprising:
upon determining the absence of the vulnerability information associated with the product within the database,
scanning, by the server, the product based on at least one vulnerability scanning technique;
identifying, by the server, the vulnerability information for the product in response to the scanning; and
updating, by the server, the database based on the vulnerability information determined for the product.

5. The method of claim 4, wherein the at least one vulnerability scanning technique comprises a Black Duck scanning technique, a Nessus scanning technique, a Nexpose scanning technique, a Webapp scanning technique, and a penetration testing technique.

6. The method of claim 1, wherein the information comprises a common vulnerability exposure (CVE) list, an impact, a remediated product version, false positives, and a download link.

7. The method of claim 1, further comprising:
transmitting, by the server, the vulnerability report to the user device; and
rendering, via a Graphical User Interface (GUI) of the user device, the vulnerability report to a user.

8. A system for generating a vulnerability report for a product, the system comprising:
a processor; and
a memory communicatively coupled to the processor, wherein the memory stores processor instructions, which when executed by the processor, cause the processor to:
obtain a set of parameters corresponding to the product associated with a user device, wherein the set of parameters comprises a product name, a pre-installed product version, a license information, and user device configurations;
analyse a database to determine one of a presence or an absence of vulnerability information associated with the product within the database, wherein the vulnerability information comprises one or more issues associated with a current product version and each of a set of existing product versions of the product;
in response to analyse, extract the vulnerability information for the product, upon determining the presence of the vulnerability information;
validate each of the set of parameters based on the vulnerability information extracted for the product; and
generate a vulnerability report corresponding to the product in a pre-defined format based on the validating, wherein the vulnerability report comprises information associated with the current product version and each of the set of existing product versions.

9. The system of claim 8, wherein the database comprises vulnerability information associated with a plurality of products, and wherein the database is updated with the vulnerability information before release of each product version of each of the plurality of products.

10. The system of claim 8, wherein the one or more issues comprises issues associated with components, ports, platforms, web services, an End of Life (EOL) of associated third party components, and an EOL of the product.

11. The system of claim 8, further comprising:
upon determining the absence of the vulnerability information associated with the product within the database,
scan the product based on at least one vulnerability scanning technique;
identify the vulnerability information for the product in response to the scanning; and
update the database based on the vulnerability information determined for the product.

12. The system of claim 11, wherein the at least one vulnerability scanning technique comprises a Black Duck scanning technique, a Nessus scanning technique, a Nexpose scanning technique, a Webapp scanning technique, and a penetration testing technique.

13. The system of claim 8, wherein the information comprises a common vulnerability exposure (CVE) list, an impact, a remediated product version, false positives, and a download link.

14. The system of claim 8, further comprising:
transmit the vulnerability report to the user device; and
render, via a Graphical User Interface (GUI) of the user device, the vulnerability report to a user.

15. A non-transitory computer-readable medium storing computer-executable instructions for generating a vulnerability report for a product, the stored instructions, when executed by the processor, causes the processor to perform operations comprising:
obtaining a set of parameters corresponding to the product associated with a user device, wherein the set of parameters comprises a product name, a pre-installed product version, a license information, and user device configurations;
analysing a database to determine one of a presence or an absence of vulnerability information associated with the product within the database, wherein the vulnerability information comprises one or more issues associated with a current product version and each of a set of existing product versions of the product;
in response to analysing, extracting, the vulnerability information for the product, upon determining the presence of the vulnerability information;
validating each of the set of parameters based on the vulnerability information extracted for the product; and
generating a vulnerability report corresponding to the product in a pre-defined format based on the validating, wherein the vulnerability report comprises information associated with the current product version and each of the set of existing product versions.

16. The non-transitory computer-readable medium of claim 15, wherein stored instructions, when executed by the processor, further causes the processor to perform operations comprising:
upon determining the absence of the vulnerability information associated with the product within the database,
scanning the product based on at least one vulnerability scanning technique;
identifying the vulnerability information for the product in response to the scanning; and
updating the database based on the vulnerability information determined for the product.

17. The non-transitory computer-readable medium of claim 15, wherein the stored instructions, when executed by the processor, further causes the processor to perform operations comprising:
transmitting the vulnerability report to the user device; and
rendering the vulnerability report to a user.
